(19) United States
(12) Patent Application Publication
(10) Pub. No.: US 2005/0210725 A1
(43) Pub. Date: Sep. 29, 2005

(54) Display apparatus

(76) Inventors: Richard Stolls, Manhasset, NY (US); Mike Larusso, Waldwick, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 10/811,167

(22) Filed: Mar. 26, 2004

(51) Int. Cl. G09F 13/04

(52) U.S. Cl. 40/610; 40/560; 40/564

(57) ABSTRACT

A display apparatus includes an adaptive frame supporting a flexible covering member. The metal frame is optionally separated into transportable and storable portions and the covering member may include display portions, and replacement or covering display panels on an outer surface. The present embodiment accepts a plurality of internal and external lighting assemblies and the frame designs allow a user to store the apparatus as a kit.

### BACKGROUND OF THE INVENTION

1. Field of the Invention

The present invention relates to a display apparatus. More specifically, the present invention relates to a portable soft-sided display apparatus including removable side panels and an internal light source.

2. Description of the Related Art

Conventional display units include external supportive frames and permanently affixed posters or other printed matter. This type of metal frame is often adjustable enabling the poster or other printed matter to be displayed at a desired height. Unfortunately, this type of conventional display unit, for example an easel, while adjustable, is not collapsible for easy storage and transport. Other concerns include the easy damage to poster and printed matter due to it's inelastic nature (i.e. printed paper) and the difficulty in retaining the printed matter in a convenient display position.

Conventional lighting boxes provide a continuous frame enclosing one or more fixed lighting units and a rigid translucent or transparent member (e.g. plexiglass) covering one side. This type of lighting box frequently positioned horizontally and is used by photographers, architects, and designers to view their work. Other types of lighting boxes are employed in advertizing spaces and store fronts where a photograph or poster to be displayed is fixed to an inside surface of the rigid translucent or transparent member with adhesive tape or thin metal wires not easily noticed by the viewing public. This type of lighting box design raises overheating and fire concerns through venting failures (particularly where incandescent lights are used), and employs easily damaged and torn rigid photographs and posters.

An additional detriment found with conventional lighting boxes, particularly large lighting boxes found within stores is their large size and rigid construction preventing easy break-down for storage or transport by a single person. Due to the large sizes of conventional lighting box designs and the need to use rigid print materials (photographs and posters), it is often difficult for a single operator to safely and easily position and fix the printed matter with tape or thin wires during initial assembly. It is also difficult to replace a printed advertizement, a task often involving two or more employees.

A further detriment to conventional lighting box design is their failure to easily adapt to alternative size demands. Typically conventional lighting box designs are constructed in a single-sized rigid manner, often of wood or metal and originally selected by a customer to fit a particular location. As a consequence, conventional lighting box designs are not easily adapted to revised advertizing designs, for example alternative seasonal designs, requiring differently sized lighting boxes with different dimensions.

A final disadvantage of conventional lighting box and display unit design involves the rigidity of the original lighting-source designs used. Conventional lighting boxes are designed for use with one type of lighting fixture throughout their operative life span. Where conventional display units include lighting fixtures, these too are non-adaptive to changing design plans and the lighting fixtures are often permanently fixed to the frame, requiring damage to remove. In sum, conventional units seem incapable of adapting to the ever-changing lighting technology so useful in advertizing and promotion, often quickly rendering inadequate a recently produced lighting box or display unit design.

What is needed is a light-weight and easily adaptive lighting box design, easily stored, transported, and set up by a single individual, having both durable and easily changed promotional materials and ready adaptivity to changing lighting technology.

### OBJECTS AND SUMMARY OF THE INVENTION

An object of the present invention is to provide a lighting unit design that overcomes at least one of the detriments noted above.

The present invention relates to a display apparatus includes an adaptive frame supporting a flexible covering member. The metal frame, in at least one embodiment, is easily separated into transportable and storable portions and the covering member may include replacement display panels or include display materials directly on an outer surface. The unit is easily assembled by a single or few users, and is particularly easy to adapt to the rapid needs of seasonal advertising. The present embodiment accepts a plurality lighting assemblies and frame designs allowing a user to store the apparatus as a kit, easily adapting to seasonal display requirements.

According to one embodiment of the present invention, there is disclosed a display apparatus, comprising: a support frame member projecting from a support surface and defining an inner volume, a flexible covering member including means for removably covering the frame member and bounding the inner volume therein, the support frame supporting the flexible covering member and defining at least one visual plane on the covering member, the display apparatus enabling the positioning of at least one visual image on the covering member proximate the visual plane and available for visual approach by an external viewer, and at least a lighting assembly positioned within the bounded inner volume, whereby at least a light projected from the lighting assembly illuminates the covering member, enabling an easy perception of the visual image by the external viewer.

According to another embodiment, there is a display apparatus, wherein: the support frame member further comprising means for rapidly assembling and disassembling the frame member, whereby elements of the frame member may be rapidly assembled into a frame unit and rapidly disassembled by a user allowing easy storage and transportation of the display apparatus in a compact shape.

According to another embodiment, there is a display apparatus, wherein: the lighting assembly further comprises at least one of a suspended lighting unit, a fixed lighting unit, a mobile lighting unit controllably movable relative to the support frame member, and a projecting display unit.

According to another embodiment, there is a display apparatus, further comprising: at least one external lighting assembly fixed to the support frame effective to project the illumination on a surface of the covering member proximate the visual image.

According to another embodiment, there is a display apparatus, wherein: the lighting assembly includes at least the projecting image display unit, and the projecting display unit being one of a video projector and a fixed image projector, whereby the projecting display unit is effective to project at least one image on an internal surface of the covering member, thereby attracting the visual approach by the external viewer.

According to another embodiment, there is a display apparatus, further comprising: at least one display support projecting from the frame member external to the bounded inner volume, and the display support being at least one of a removably attached and a fixably attached display support relative to the support frame, whereby the display support allows a user to modify the design of the apparatus to include an additional display for supporting items for viewing external to the bounded inner volume, while not inhibiting a rapid removal of the flexible covering member.

According to another embodiment, there is a display apparatus, wherein: the frame member comprises at least one of a plurality of rigid framing members, a flexibly resilient framing member, a support footing member, a means for rolling the display apparatus relative to a support surface, and a means for manually or automatically rotating the display apparatus relative to the support surface, whereby the at least one enhances a user convenience of the display apparatus.

According to another embodiment, there is a display apparatus, wherein: the flexible covering member includes at least one of a top opening and a bottom opening, and each opening in combination with and the bounded inner volume being effective to allow the escape of a thermal energy created during operation of the at least one lighting assembly from the bounded inner volume thereby minimizing a thermal degradation of the flexible covering member and the lighting assembly.

According to another embodiment there is a display apparatus, wherein: the flexible covering member includes at least one removable flexible display member, the at least one display member including the at least one visual image, thereby enabling the visual approach by the external viewer, and means for removably fixing the at least one display member on the flexible covering member, whereby the means for removably fixing enables a simple removal of the flexible display member for convenient storage without necessitating complete removal of the flexible covering.

According to another embodiment there is a display apparatus, wherein: the means for removably fixing the at least one display member includes at least one of a plurality of mechanical snaps, a plurality of velcro members, and a zipper member, the at least one positioned proximate an outer boundary of the visual plane, and the at least one enabling the flexible display member to be rapidly affixed to the flexible covering for easy assembly and rapidly removed for storage, thereby facilitating a rapid and inexpensive change in the visual image by a user.

According to another embodiment there is a display apparatus, wherein: at least one seam in the flexible covering member, a closure member positioned along the seam, the closure member being at least one of a zipper closure member, a snap closure member, a laced closure member, and a velcro closure member, and the closure member being effective to open the seam during an assembly or disassembly of the flexible covering member with the frame member and speeding the process, while allowing a closing of the seam after assembly thereby enabling a rapid change between flexible coverings.

According to another embodiment there is a display apparatus, wherein: the lighting assembly further comprises automated means for receiving and storing a programed input and driving a control means of the lighting assembly, thereby enabling a selected and programmed lighting operation to be used to increase the advertizing effectiveness of the display apparatus, and power distribution means for receiving an external power and for distributing an input power to the lighting assembly and the automated means, whereby safe electrical operation of the display apparatus is improved.

According to another embodiment there is a display apparatus, wherein: the display apparatus includes at least one of the mobile lighting unit and the display projecting unit, and the automated means being effective to operate the at least one of the mobile lighting unit and the display projecting unit.

According to another embodiment there is a display apparatus, wherein: the frame member includes the plurality of rigid framing members the support footing member, the support footing member spacing the frame member from the support surface, and a plurality of spacing members spacing the support footing member from frame member, thereby presenting the visual image proximate the external viewers eye-level for easy viewing.

According to another embodiment there is a display apparatus, wherein: the flexible covering member includes both the top and the bottom openings, and at least one of the openings including means for tightening the covering member along the at least one visual plane, whereby the means for tightening minimizes winkles in the covering member and enables smoother viewing of visual image.

According to another embodiment there is a display apparatus, wherein: the top opening includes the means for tightening, the means for tightening further comprising: at least one of a plurality of adjustable strips, a draw-string means, an elastic member, a combination of the adjustable strips and the elastic member, and a combination of the elastic member and the draw-string means.

According to another embodiment there is a display apparatus, wherein: the bottom opening includes the means for tightening, the means for tightening further comprising: at least one of a second plurality of adjustable strips, a second draw-string means, a second elastic member, a combination of the second adjustable strips and the second elastic member, and a combination of the second elastic member and the second draw-string means.

According to another embodiment there is a display apparatus, wherein: the support frame member comprises at least a first bottom and a first top member, the bottom member between the top member and the support surface, and the support frame member further comprising at least a first and second side members spacing the top and bottom members apart, whereby after an assembly of the support frame, the top, bottom and first and second side members are effective to define the inner volume.

According to another embodiment there is a display apparatus, wherein: the support frame member further comprises means for rapidly assembling and disassembling the top, bottom, first side, and second side members relative to each other, whereby the members of the frame member may be rapidly assembled into a frame unit and rapidly disassembled by a user allowing easy storage and transportation of the support frame member in a compact shape.

According to another embodiment there is a display apparatus, wherein: the means for rapidly assembling and disassembling includes a plurality of male and female sections proximate respective corners of the support frame, whereby during the assembly the female members receive the male members and provide a sleeved-overlap connection of the members, and means for releasably engaging and disengaging the male and female sections thereby enabling the rapid assembly of the support frame into a rigid frame and a disassembly through separation of the male and female sections.

According to another embodiment there is a display apparatus, wherein: the lighting assembly further comprises at least one of a sound projecting unit, and a scent projecting unit.

According to another embodiment of the present invention, there is provided a display kit, comprising: a support frame member defining an inner volume, a flexible covering member including means for removably covering the frame member and for bounding the inner volume therein, the support frame supporting and tensioning the flexible covering member and defining at least one visual plane in a position available for visual approach by an external viewer, the support frame member including means for rapidly assembling and disassembling the frame member, whereby a plurality of elements of the frame member may be rapidly assembled into a frame unit and rapidly disassembled by a user allowing easy storage and transportation of the support frame member in a compact shape, and at least one lighting assembly positioned within the bounded inner volume, whereby at least a light projected from the lighting assembly illuminates at least a portion of inside of the covering member, whereby the illumination enhances a perception of the visual image by the external viewer.

According to another embodiment of the present invention, there is provided a display kit, wherein: the lighting assembly is at least one of a suspended lighting unit, a supported lighting unit, a mobile lighting unit controllably movable relative to the image, and a projecting display unit effective to project the visual image on the visual plane of the flexible covering member.

According to another embodiment of the present invention, there is provided a display kit, wherein: the frame member including at least one of a plurality of rigid framing members, a flexibly resilient framing member, and a support footing member, whereby the at least one enables the frame member and the kit to form shapes adaptive to alternative display requirements.

According to another embodiment of the present invention, there is provided a display kit, wherein: the flexible covering member includes at least one of a translucent and a semi-transparent material portion, at least one flexible display member on the flexible covering, the at least one display member including the at least one visual image, thereby enabling the visual approach by the external viewer and illumination by the at least one lighting assembly, and means for removably fixing the at least one display member to the flexible covering member, whereby the means for removably fixing enables a simple removal of the flexible display member for convenient storage without necessitating complete removal of the flexible covering member from the support frame, thereby enabling easy replacement of the visual image.

According to another embodiment of the present invention, there is provided a display kit, wherein: the means for removably fixing the at least one display member includes at least one of a plurality of mechanical snaps, a plurality of velcro members, a zipper member means, and a laced-member means, the at least one in the means for removably fixing being positioned proximate an outer boundary of the visual plane, and the at least one enabling the flexible display member to be rapidly affixed to the flexible covering for easy assembly and rapidly removed for storage, thereby facilitating a rapid and inexpensive change in the visual image by a user.

According to another embodiment of the present invention, there is provided a display kit, further comprising: at least one seam in the flexible covering, a closure member positioned along the seam, the closure member being at least one of a zipper closure member, a snap closure member, a laced closure member, and a velcro closure member, and the closure member being effective to release and open the seam during an assembly or disassembly of the flexible covering with the frame member and speed the disassembly process, while allowing a rapid closing of the seam after assembly thereby enabling a rapid change of the flexible covering.

According to another embodiment of the present invention, there is provided a display kit, wherein: the lighting assembly further comprises at least one of an automated means and a computer means for receiving and storing a user-input and driving a control of the lighting assembly, thereby enabling a selected and programmed lighting operation to be used to increase the visual attractiveness of the display kit, and power distribution means for receiving a power supply external to the apparatus and for distributing the power supply to the lighting assembly, whereby safe electrical operation of the display kit is improved.

According to another embodiment of the present invention, there is provided a display kit, wherein: the display kit includes at least one of the mobile lighting unit and display projecting unit.

According to another embodiment of the present invention, there is provided a display kit, wherein: the frame member includes the support footing member, the support footing member spacing the frame member from the support surface, and a plurality of spacing members spacing the support footing member from frame member.

According to another embodiment of the present invention, there is provided a display kit, wherein: the flexible covering member includes both the top and the bottom openings, and at least one of the openings including means for tightening the covering member along the at least one visual plane, whereby the means for tightening minimizes winkles in the covering member and enhances smooth viewing of visual image.

According to another embodiment of the present invention, there is provided a display kit, wherein: the top opening includes the means for tightening, the means for tightening further comprising: at least one of a plurality of adjustable strips, a draw-string means, an elastic member, a cross-laced means, a combination of the adjustable strips and the elastic member, and a combination of the elastic member and the draw-string means.

According to another embodiment of the present invention, there is provided a display kit, wherein: the bottom opening includes the means for tightening, the means for tightening the bottom opening further comprising: at least one of a plurality of adjustable strips, a draw-string means, an elastic member, a cross-laced means, a combination of the adjustable strips and the elastic member, and a combination of the elastic member and the draw-string means.

According to another embodiment of the present invention, there is provided a display kit, wherein: the bottom opening includes the means for tightening, the means for tightening the bottom opening further comprising: at least one of a second plurality of adjustable strips, a second draw-string means, a second elastic member, a second cross-laced means, a combination of the second adjustable strips and the second elastic member, and a combination of the second elastic member and the second draw-string means.

According to another embodiment of the present invention, there is provided a display kit, wherein: the lighting assembly further comprises at least one of a sound projecting unit and a scent projecting unit.

According to another embodiment of the present invention, there is provided a display kit, comprising: a support frame member defining an inner volume, the support frame member comprising at least first and second rigid side supports joining top and bottom sections, each side support having a first length, a flexible covering member including means for removably covering the frame member and bounding the inner volume therein, the support frame supporting and tensioning the covering material along at least one visual plane effective to position at least one visual image for easy visual approach by an external viewer, the support frame member including means for rapidly assembling and disassembling the frame member, whereby elements of the frame member may be rapidly assembled and disassembled by a user allowing easy storage and transportation in a compact shape, and at least one lighting assembly positioned within the bounded inner volume and projecting an illumination on the covering material to enhance a perception of the visual image on the flexible covering.

According to another embodiment of the present invention, there is provided a display kit, comprising: a support frame member defining an inner volume, the support frame member comprising at least first and second rigid side supports joining top and bottom sections, each side support having a first length, a flexible covering member including means for removably covering the frame member and bounding the inner volume therein, the support frame supporting and tensioning the covering material along at least one visual plane effective to position at least one visual image for easy visual approach by an external viewer, and at least one lighting assembly positioned within the bounded inner volume and projecting an illumination on the covering material to enhance a perception of the visual image on the flexible covering.

According to another embodiment of the present invention, there is provided a display kit, comprising: a support frame member defining an inner volume and including at least a plurality of upright elements having a first length, a replacement plurality of upright elements having at least a second length, the support frame member including means for rapidly assembling and disassembling the frame member, whereby the plurality of upright elements having the first length in the frame member may be rapidly assembled with a connective plurality of cross elements and replaceably interchanged with the plurality of uprights have the second length, thereby allowing a user to rapidly assemble support frames of at least first and second heights and rapidly disassemble the support frame for storage and transportation in a compact size, at least one flexible covering member including means for removably covering the frame member at a selected height and bounding the inner volume therein, and the support frame supporting and tensioning the covering material along at least one visual plane effective to position at least one visual image available for easy visual approach by an external viewer.

According to another embodiment of the present invention, there is provided a display kit, comprising: a support frame member defining an inner volume, the support frame member comprising at least first and second rigid side supports joining top and bottom sections, each side support having a first length, a flexible covering member including means for removably covering the frame member and bounding the inner volume therein, the support frame supporting and tensioning the covering material along at least one visual plane effective to position at least one visual image available for easy visual approach by an external viewer, and the support frame member including means for rapidly assembling and disassembling the frame member, whereby elements of the frame member may be rapidly assembled and disassembled by a user allowing easy storage and transportation in a compact shape.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a perspective view of a frame member according to one embodiment of the present invention.

FIG. 2 is a perspective view of one embodiment of the present invention including one embodiment of an adaptive covering member.

FIG. 3 is an exploded perspective view of an alternative embodiment of the present invention.

### DETAILED DESCRIPTION OF THE PREFERRED EMBODIMENTS

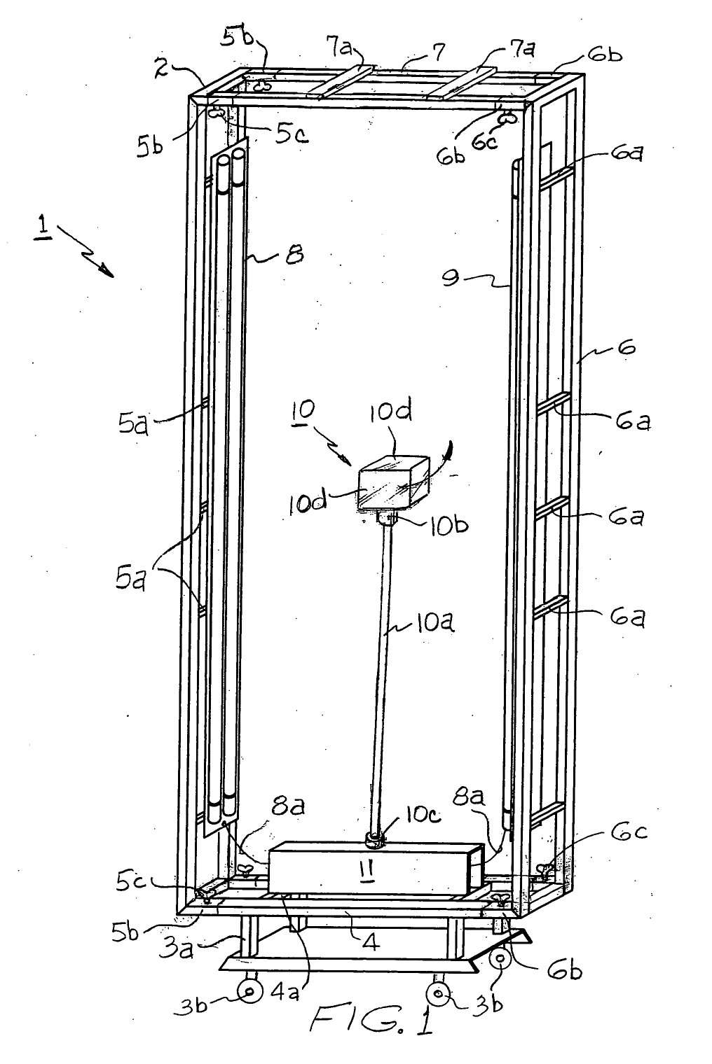

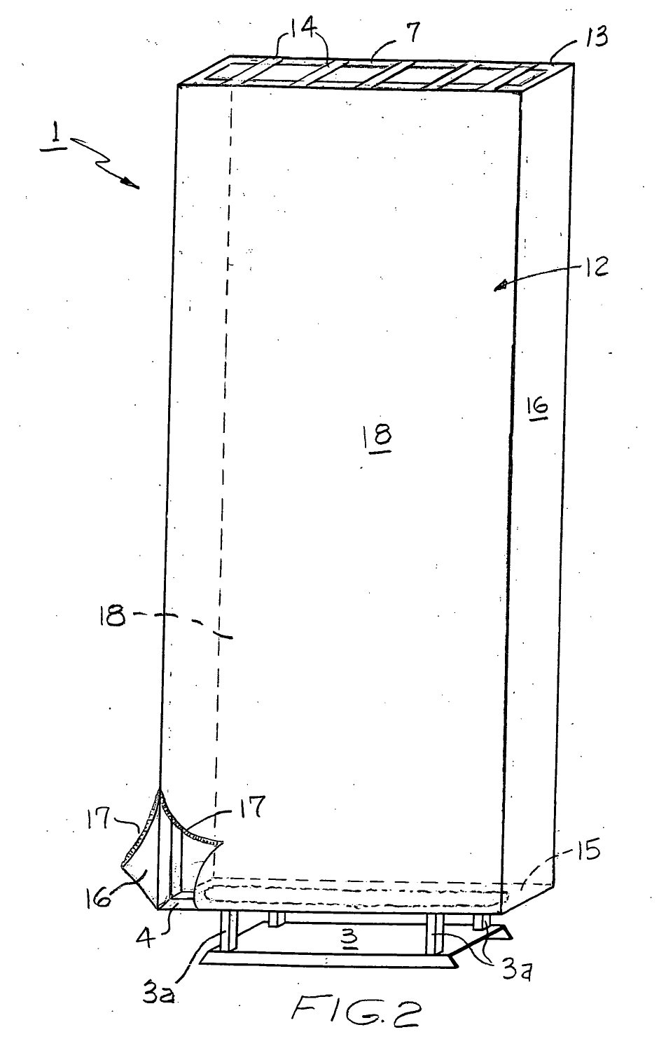

Referring now to FIGS. 1 and 2 a display unit 1 includes an supportive frame 2, positioned on a support footing 3, and an outer covering member 12.

Support footing 3 spaces display unit 1 from a support surface and includes spacing members 3a joining footing 3 with a bottom member 4 of frame 2, as shown. A plurality of wheel members 3b may alternatively be positioned to support footing 3 and provide a wheeled mobility to display unit 1.

In the embodiment shown, bottom member 4 includes two parallel outer edge members spaced by a plurality of cross supports 4a. Two side members 5, 6 project upward from bottom member 4 and are similarly formed with outer edge members spaced by respective pluralities of cross members 5a, 6a. A top member 7 having similar parallel outer edge members spaced by a plurality of cross supports 7a joins the upper edges of side members 5, 6.

Extensions 5b, 6b extend inwardly from respective top and bottom sides of respective side members 5, 6 as shown. Extensions 5b, 6b extend over and receive male inner extensions (not shown) projecting from, respectively the outer parallel edge members of top member 7 and bottom member 4. In this manner, those skilled in the art will recognize that extensions 5b, 6b form female sections engaging respective male sections from the outer ends of top and bottom members 7, 4 in a socket-like manner.

Wing nuts serve as connecting means 5c, 6c on respective extensions 5b, 6b and threadably extend through the walls of extensions 5b, 6b enabling a compressive and friction engagement of the male sections projecting from top and bottom members 7, 4, as shown, although alternative positions should be readily apparent to those skilled in the art. In this manner, connective means 5c, 6c fix side members 5, 6 to respective top and bottom members 4, 7. Alternative embodiments envision alternative length side members 5, 6 readily adapting to a user's display needs throughout the year, from sale season to sale season, for example by allowing ready replacement with different length upright or side members.

In sum, those skilled in the art of frame assembly should readily recognize that connecting means 5c, 6c and respective male/female extensions enable an easy and rapid assembly and disassembly of the present embodiment. It should also be recognized that the present embodiment may be adapted to alternative sizes by simply replacing present side members 5, 6, with those of different lengths (36″, 42″, 60″ or 84″) or shapes (arcuate, round, wavy, twisted etc.). Due to the simple male-female socket design side members may be alternatively shaped and may even be formed from a flexible material effective to retain the shape of the covering member 12. As a consequence, the present invention envisions ready adaptation to display units shaped substantially as circles (with a flat bottom), rectangles, octagonals, or free form wave-type (back and fourth) shapes. Finally, while the present embodiment discusses the instant preference for ready interchangeability and collapse-ability of the frame member (for convenience), those skilled in the art will recognize that the present invention may be practiced with a rigid-non-changeable frame member without departing from the scope and spirit herein.

Lighting units 8, 9 are removably joined to respective side members 5, 6 as shown. In the present embodiment, lighting units 8, 9 are fluorescent lights with circuit extensions 8a, 9a extending downwardly and inwardly to a protective unit and spacer 11. An electrical connection point or an electrical drive unit (both not shown) may be removably and replaceably included within spacer 11 providing protection and a neat appearance to an external viewer. One embodiment is envisioned to provide a spacer 11 sufficiently tough to allow an operator to stand on during assembly, thereby allowing a vertically challenged assembly to assemble a particularly high frame 2 (i.e. height of 84″ or 96″ inches).

Lighting units 8, 9 are attached to cross members 5a, 6a with threaded screws or bolts in the present invention allowing a ready removability and replacement with alternative types of lights (incandescent, fiber-optic, arc-lights etc.) Alternative means for attaching lighting units 8, 9 to side members 5, 6 may include clamps, magnetic members, or simple hooks allowing ready disassembly by an operator. Alternative embodiments to the present invention also envision lighting units 8, 9 being mobile/robotic lights including a motor or a robotic movement of a type well known in the art. In this manner those skilled in the art will recognize that lighting units 8, 9 may additionally include means for movement relative to frame 2 thereby attracting additional notice to the display or emphasizing different feature printed on covering member 12 to achieve the same purpose.

An additional light unit 10, is positioned within frame 2, as shown. In this embodiment, light unit 10 is positioned on a spacing support 10a extending upwardly from spacer and protective unit 11. A rotating bearing 10b joins lighting unit 10 with spacing support 10a and enables a plurality of display faces 10d on lighting unit 10 to rotate relative to frame 2. A fixing bracket 10c fixes a bottom support 10a to protective unit 11. Electronic connections and even microprocessor or programmable controls for lighting unit 10 extend along spacing support 10a and enable an operator to programmably control light unit 10.

In the present embodiment, light unit 10 is rotating light-emitting unit with a faceted outer surface programmable to rotate at variable speeds to draw attention to lighting display 1 as the lights pass over a back surface of covering member 12.

Those skilled in the art of lighting and electrical design should recognize that alternative designs to the present embodiment. One alternative embodiment envisions light unit 10 positioned extending downward from top member 7. Another alternative embodiment envisions multiple colored lights projecting outward from light unit 10, with flexible stems, enabling an assembler to direct focused light at particularly selected portions of a display printed on covering member 12.

Referring now to FIG. 2, a flexible covering member 12 is positionable over frame 2 as shown. Covering member 12 includes a pair of sides 16, 16 joining front and back members 18, 18. A top member 13 includes adjusting strips 14 spaced from alternatively front and back members 18, 18 (as shown) or additionally from side members 16, 16 to ensure that covering member 12 falls or drapes smoothly and tightly over frame 2. An alternative embodiment replaces strips 14 with an elastic gathering, having a central opening allowing any light-generated heat to escape from frame 2. In use, one embodiment of the present invention includes a printed advertizement or attractive image or visual display on an external or internal surface (or both) of at least one plane for covering member 12 generated by frame 2. For example, a printed image of a cosmetics model using a cosmetics device may be printed on covering member 12 and illuminated from behind by light units 8, 9, 10 or a combination thereof.

A bottom member 15 partially spans the bottom opening of bottom member 4, and as shown, includes an elastic gathering or a type of slip-loop or draw-string type (string in a fold of the fabric) gathering having a central opening. In this manner, light display unit 1, in combination with covering member 12 forms a bounded space effective to create a chimney effect to flush any warm air created by internal lights upward and outwardly, while drawing fresh air inwardly from below.

In one alternative embodiment, a zipper, snap, or velcro seam 17 along at least one side of covering member 12 serves as a closure member to join edges of said seam. Seam 17 may exist along only a single side (as shown) or on multiple sides. In the embodiment shown, a user can partial open seam 17, thereby releasing tension on bottom member 15 and allowing the user to slip covering member 12 over the top of frame 2.

Once covering member 12 is in place, seam 17 is closed tightening the outer surface of covering member 12. The user then adjusts adjusting strips 14 and snugs covering member 12 to frame 2. The user then initiates light units 8, 9, and 10.

Alternative embodiments for covering member 12 may exclude seam 17 and adjustment straps 14, particularly where covering member 12 is elastic and stretchy. Additional embodiments exist allowing portions of covering member 12 (for example along sides 16, 16, or front/back members 18, 18) to be open, covered with mesh openings, or include replacement sections formed from a visually appealing material (for example reflective Mylar) or translucent or transparent plastic.

Those skilled in the art should recognize that, after assembly with frame 2, covering member 12, defines visual planes dictated by the shape of frame 2. In other words, where frame 2 defines a rectangular shape (shown), or a triangular shape, square shape, wave shape, or another symmetrical or asymmetrical shape, covering member 12 is adapted to cover the frame, bound the inner volume defined by the various members of frame 2, and define at least one visual plan for the relative geometric or random shape created by the shape of frame 2.

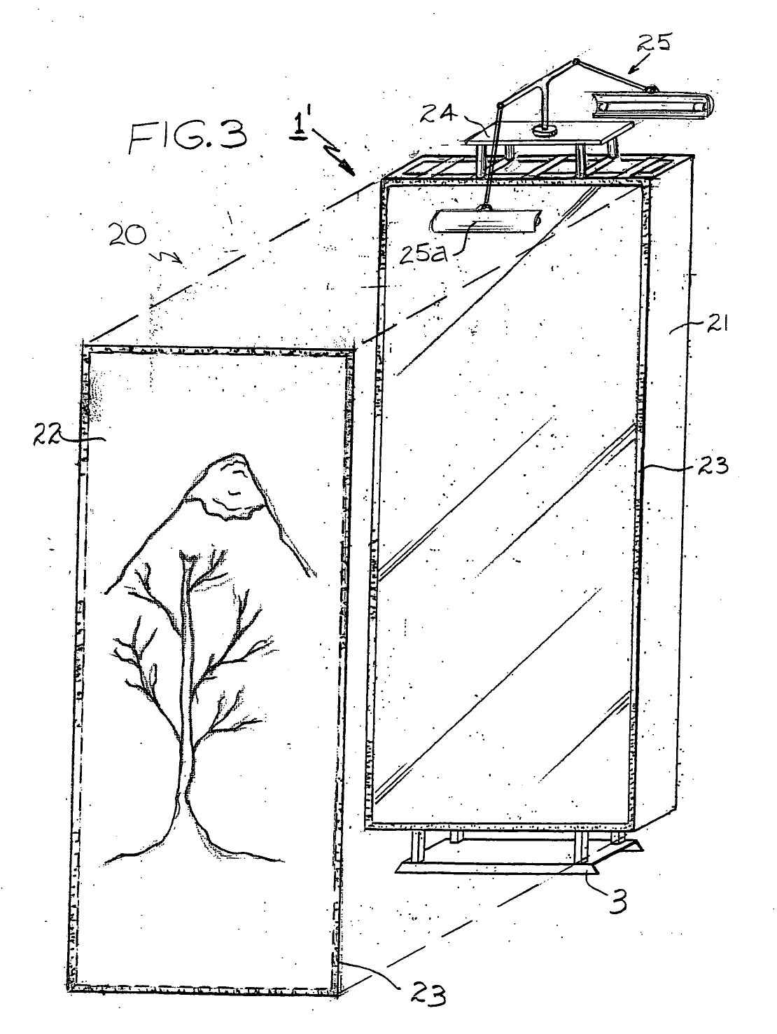

Referring now to FIG. 3, an alternative embodiment to the present invention presents a display unit 1′ having covering member 20 including a visual display member 22 removably fastened to at least one surface of a support backing member 21 by a fixing means 23, for example velcro, or a zipper, or other removable means common in the fabric-joining trade.

One benefit of this present embodiment is the easy adaptability for each surface of lighting display unit 1. In one example, for a first seasonal display, a user removes a past season's display member 22 (i.e. Christmas display), and replaces it with an easily stored rolled member 22 (i.e. Valentines Day). In this manner, a single backing member 21 may be formed to accept multiple display members 22, perhaps on alternative sides.

In another example, lighting display unit 1 may be positioned centrally between alternative locations within a business and a user may fix relevant display members 22 to respective alternative sides of display unit 1. In this manner, lighting display unit 1 may serve as a temporary wall, while still serving as a visually appealing display device.

It should also be recognized within the scope and spirit of the present invention that covering members 12, 20 may be formed from materials readily accepting a printed pattern, or a lithograph (ink jet) of an advertizing display. Those skilled in the art of display design should appreciate that the present use of alternatively flexible and inflexible types of covering members 12, 20 enables a broad range of display options, heretofore unavailable to the display market.

It should also be apparent that display members 12, 20 may be constructed it additionally function as display racks and support examples of displayed clothing items thereby providing an attractively lit backdrop to the clothing.

In another alternative embodiment of the present invention, multiple lighting units may be positioned together and covered with a single large display member 12, 20 forming a large mural to attract attention from a long distance.

A removable display shelf 24 may be removably joined to top member 7 (shown) or onto bottom member 4, or some other portion of frame 2. In this manner, display shelf 24 may be used to support a display item for sale or an additional type of advertizement in close proximity to main display unit 1.

An additional embodiment may include a rigid or flexible external lighting unit 25 similarly removably joined to top member 7, display shelf 24 (shown), or bottom member 4 in a manner directing light onto the illuminated display surface of covering members 12, 20. In the embodiment shown, external lighting unit includes two opposing lighting members 25a, but the present invention recognizes that alternative embodiments exist with single lights, flexible suspended lights, and other lighting elements common in the advertizing trade.

One major advantage of the present embodiment is the ready collapsability of display apparatus 1. The unit is easily disassembled by removing outer covering member 12, releasing connective means 5c, 6c, and removing side members 5, 6. In this manner, a retail store may have a wide selection of different length and types of side members 5, 6 for only a hand-ful of support footings 3, bottom and top members 4, 7. An additional benefit is that display unit may be stored in a disassembled state in a relative small space with a wide plurality of seasonal coverings 12, 20, 21, 22, and a wide variety of lighting members 8, 9, 10, and 25.

In another alternative embodiment, where lighting members 8, 9, 10 and 25 are selected from a broad range of lighting types (fluorescent, halogen, arc, and incandescent) an end user may retain a library (selection) of lighting types easily interchangeable through out the advertizing season to achieve alternative lighting designs.

An another alternative embodiment, frame 2 may be adaptively modified (without wheels 3b) enabling a second display unit 1 to rest upon top member 7. In this way, an end user may additionally create alternating heights without the need for a wide selection of side members 5, 6.

Another alternative embodiment envisions a rotating display formed integrally with display unit 24, or with support footing 3, enabling display apparatus 1 to rotate at a top or fully, as desired by an end user.

In yet another alternative embodiment, it is envisioned that the inner area defined and bounded by frame 2 may additionally enclose a sound (speaker unit) or scent generating device (smoke/essence-releasing device) to enhance the ability of the display device to attract attention from consumers and the public at large. As noted above, these types of devices may be positioned within the bounded frame 2 and optionally controlled by an automated mechanism (electrical/mechanical) or a computer control mechanism positioned within the area formed by protective unit/spacer 11. In this manner, display unit 1 may present a coordinated and timed display (visual design, light enhancement and movement, sound, and optionally scent) controlled by an automated or computerized control mechanism allowing easy set up and maintenance.

It should be further understood, that light unit 10 is replacable with another type of projecting unit capable of projecting moving light, fixed visual images, moving visual images, a recorded movie or directed advertizement etc. on the inner surface of covering member 12, 20 and thereby providing an additional and beneficial aspect to the present invention. As a consequence, a reader should understand placing an image on support covering member 12 or in other may include projecting the image on an inner surface, printing the image on a removable outer display member 23, printing an image on a surface of covering member 12 or in any other manner commonly understood in the art of image display. It is additionally understood, that a plurality of steps for placing an “image” on member 12, may include a combination of all three; namely printing, projecting, and layering and image. It is additionally understood, that the “image” may be a transparent (border only), translucent, or opaque image, or any other form of image commonly recognized in the display and advertizing arts.

As used herein, it should be obvious to those skilled in the art of construction that frame 2 serves both to create a definable bounded inner volume (for retaining lighting, motion, or sound generating devices, and to support an outer covering means (12, 20 etc.) resting on and supported by the frame. The bounded inner volume is shaped to include at least one display plane where an advertizing display is positioned for viewing.

As used herein, the phrase flexible covering member or covering member should be understood as describing at least a generally flexible member, a flexible and elastic member (i.e. a fabric including spandex or other elastic fibers), a flexible and inelastic woven material, a non-woven flexible material like Mylar or other plastic sheeting, or a combination of any; each effective to serve the function of being flexible, and hence easily rolled, stored, and transported, and serving the function of being suitable as a cover for a rigid or semi-rigid support frame, and hence easily accepting the shape of a portion of the support frame. For example, a translucent and a rigid plastic sheeting member or an flexible and possibly elastic woven member may all be readily used may be used removably cover a rigid support frame or a slightly flexible support frame.

In sum, those skilled in the art of display design should recognize at least the following benefits from at least one of the above described embodiments.

(1) Easy breakdown and portability.

(2) Easy adaption to a variety of display sizes and shapes.

(3) Easy adaption to a variety of lighting schemes, units, automated lighting displays, and creative lighting assemblies.

(4) Elimination of the risk of thermal degradation of either the display unit itself or the advertising displays supported thereon through the integral design of a hot-air-exit-opening, or the thermal dissipation ease of a thin flexible member.

(5) Easy incorporation of a variety of sound and scent-generating attractive elements.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the spirit and scope of this invention as defined in the following claims.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail functions by relying on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1. A display apparatus, comprising:
a support frame member projecting from an external support surface and defining an inner volume;
a flexible covering member including means for removably covering said frame member and bounding said inner volume therein;
said support frame supporting said flexible covering member and defining at least one visual plane on said covering member;
said display apparatus enabling the positioning of at least one visual image on said covering member proximate said visual plane and available for visual approach by an external viewer; and
at least a lighting assembly positioned within said bounded inner volume, whereby at least a light projected from said lighting assembly illuminates said covering member, enabling an easy perception of said visual image by said external viewer.

2. A display apparatus, according to claim 1, wherein:
said support frame member further comprising means for rapidly assembling and disassembling said frame member, whereby elements of said frame member may be rapidly assembled into a frame unit and rapidly disassembled by a user allowing easy storage and transportation of said display apparatus in a compact shape.

3. A display apparatus, according to claim 2, wherein:
said lighting assembly further comprises at least one of a suspended lighting unit, a fixed lighting unit, a mobile lighting unit controllably movable relative to said support frame member, and a projecting display unit.

4. A display apparatus, according to claim 3, further comprising:
at least one external lighting assembly fixed to said support frame effective to project said illumination on a surface of said covering member proximate said visual image.

5. A display apparatus, according to claim 2, wherein:
said lighting assembly includes at least said projecting image display unit; and
said projecting display unit being one of a video projector and a fixed image projector, whereby said projecting display unit is effective to project at least one image on an internal surface of said covering member, thereby attracting said visual approach by said external viewer.

6. A display apparatus, according to claim 3, further comprising:
at least one display support projecting from said frame member external to said bounded inner volume; and
said display support being at least one of a removably attached and a fixably attached display support relative to said support frame, whereby said display support allows a user to modify the design of said apparatus to include an additional display for supporting items for viewing external to said bounded inner volume, while not inhibiting a rapid removal of said flexible covering member.

7. A display apparatus, according to claim 2, wherein:
said frame member comprises at least one of a plurality of rigid framing members, a flexibly resilient framing member, a support footing member, a means for rolling said display apparatus relative to a support surface, and a means for manually or automatically rotating said display apparatus relative to said support surface, whereby said at least one enhances a user convenience of said display apparatus.

8. A display apparatus, according to claim 1, wherein:
said flexible covering member includes at least one of a top opening and a bottom opening; and
each said opening in combination with and said bounded inner volume being effective to allow the escape of a thermal energy created during operation of said at least one lighting assembly from said bounded inner volume thereby minimizing a thermal degradation of said flexible covering member and said lighting assembly.

9. A display apparatus, according to claim 1, wherein:
said flexible covering member includes at least one removable flexible display member;
said at least one display member including said at least one visual image, thereby enabling said visual approach by said external viewer; and
means for removably fixing said at least one display member on said flexible covering member, whereby said means for removably fixing enables a simple removal of said flexible display member for convenient storage without necessitating complete removal of said flexible covering.

10. A display apparatus, according to claim 9, wherein:
said means for removably fixing said at least one display member includes at least one of a plurality of mechanical snaps, a plurality of velcro members, and a zipper member;
said at least one positioned proximate an outer boundary of said visual plane; and
said at least one enabling said flexible display member to be rapidly affixed to said flexible covering for easy assembly and rapidly removed for storage, thereby facilitating a rapid and inexpensive change in said visual image by a user.

11. A display apparatus, according to claim 8, further comprising:
at least one seam in said flexible covering member;
a closure member positioned along said seam;
said closure member being at least one of a zipper closure member, a snap closure member, a laced closure member, and a velcro closure member; and
said closure member being effective to open said seam during an assembly or disassembly of said flexible covering member with said frame member and speeding the process, while allowing a closing of said seam after assembly thereby enabling a rapid change between flexible coverings.

12. A display apparatus, according to claim 3, wherein:
said lighting assembly further comprises automated means for receiving and storing a programed input and driving a control means of said lighting assembly, thereby enabling a selected and programmed lighting operation to be used to increase the advertizing effectiveness of said display apparatus; and
power distribution means for receiving an external power and for distributing an input power to said lighting assembly and said automated means, whereby safe electrical operation of said display apparatus is improved.

13. A display apparatus, according to claim 12, wherein:
said display apparatus includes at least one of said mobile lighting unit and said display projecting unit; and
said automated means being effective to operate said at least one of said mobile lighting unit and said display projecting unit.

14. A display apparatus, according to claim 7, wherein:
said frame member includes said plurality of rigid framing members said support footing member;
said support footing member spacing said frame member from said support surface; and
a plurality of spacing members spacing said support footing member from frame member, thereby presenting said visual image proximate said external viewers eye-level for easy viewing.

15. A display apparatus, according to claim 8, wherein:
said flexible covering member includes both said top and said bottom openings; and
at least one of said openings including means for tightening the covering member along said at least one visual plane, whereby said means for tightening minimizes winkles in said covering member and enables smoother viewing of visual image.

16. A display apparatus, according to claim 15, wherein:
said top opening includes said means for tightening, said means for tightening further comprising:
at least one of a plurality of adjustable strips, a draw-string means, an elastic member, a combination of said adjustable strips and said elastic member; and a combination of said elastic member and said draw-string means.

17. A display apparatus, according to claim 16, wherein:
said bottom opening includes said means for tightening, said means for tightening further comprising:
at least one of a second plurality of adjustable strips, a second draw-string means, a second elastic member, a combination of said second adjustable strips and said second elastic member; and a combination of said second elastic member and said second draw-string means.

18. A display apparatus, according to claim 1, wherein:
said support frame member comprises at least a first bottom and a first top member, said bottom member between said top member and said support surface; and
said support frame member further comprising at least a first and second side members spacing said top and bottom members apart, whereby after an assembly of said support frame, said top, bottom and first and second side members are effective to define said inner volume.

19. A display apparatus, according to claim 18, wherein:
said support frame member further comprises means for rapidly assembling and disassembling said top, bottom, first side, and second side members relative to each other, whereby said members of said frame member may be rapidly assembled into a frame unit and rapidly disassembled by a user allowing easy storage and transportation of said support frame member in a compact shape.

20. A display apparatus, according to claim 19, wherein:
said means for rapidly assembling and disassembling includes a plurality of male and female sections proximate respective corners of said support frame, whereby during said assembly said female members receive said male members and provide a sleeved-overlap connection of said members; and
means for releasably engaging and disengaging said male and female sections thereby enabling said rapid assembly of said support frame into a rigid frame and a disassembly through separation of said male and female sections.

21. A display apparatus, according to claim 3, wherein:
said lighting assembly further comprises at least one of a sound projecting unit, and a scent projecting unit.

22. A display kit, comprising:
a support frame member defining an inner volume;
a flexible covering member including means for removably covering said frame member and for bounding said inner volume therein;
said support frame supporting and tensioning said flexible covering member and defining at least one visual plane in a position available for visual approach by an external viewer;
said support frame member including means for rapidly assembling and disassembling said frame member, whereby a plurality of elements of said frame member may be rapidly assembled into a frame unit and rapidly disassembled by a user allowing easy storage and transportation of said support frame member in a compact shape; and
at least one lighting assembly positioned within said bounded inner volume, whereby at least a light projected from said lighting assembly illuminates at least a portion of inside of said covering member, whereby said illumination enhances a perception of said visual image by said external viewer.

23. A display kit, according to claim 22, wherein:
said lighting assembly is at least one of a suspended lighting unit, a supported lighting unit, a mobile lighting unit controllably movable relative to said image, and a projecting display unit effective to project said visual image on said visual plane of said flexible covering member.

24. A display kit, according to claim 22, wherein:
said frame member including at least one of a plurality of rigid framing members, a flexibly resilient framing member, and a support footing member, whereby said at least one enables said frame member and said kit to form shapes adaptive to alternative display requirements.

25. A display kit, according to claim 22, wherein:
said flexible covering member includes at least one of a translucent and a semi-transparent material portion;
at least one flexible display member on said flexible covering;
said at least one display member including said at least one visual image, thereby enabling said visual approach by said external viewer and illumination by said at least one lighting assembly; and
means for removably fixing said at least one display member to said flexible covering member, whereby said means for removably fixing enables a simple removal of said flexible display member for convenient storage without necessitating complete removal of said flexible covering member from said support frame, thereby enabling easy replacement of said visual image.

26. A display kit, according to claim 25, wherein:
said means for removably fixing said at least one display member includes at least one of a plurality of mechanical snaps, a plurality of velcro members, a zipper member means, and a laced-member means;
said at least one in said means for removably fixing being positioned proximate an outer boundary of said visual plane; and
said at least one enabling said flexible display member to be rapidly affixed to said flexible covering for easy assembly and rapidly removed for storage, thereby facilitating a rapid and inexpensive change in said visual image by a user.

27. A display kit, according to claim 22, further comprising:
at least one seam in said flexible covering;
a closure member positioned along said seam;
said closure member being at least one of a zipper closure member, a snap closure member, a laced closure member, and a velcro closure member; and
said closure member being effective to release and open said seam during an assembly or disassembly of said flexible covering with said frame member and speed the disassembly process, while allowing a rapid closing of said seam after assembly thereby enabling a rapid change of said flexible covering.

28. A display kit, according to claim 23, wherein:
said lighting assembly further comprises at least one of an automated means and a computer means for receiving and storing a user-input and driving a control of said lighting assembly, thereby enabling a selected and programmed lighting operation to be used to increase the visual attractiveness of said display kit; and
power distribution means for receiving a power supply external to said apparatus and for distributing said power supply to said lighting assembly, whereby safe electrical operation of said display kit is improved.

29. A display kit, according to claim 23, wherein:
said display kit includes at least one of said mobile lighting unit and display projecting unit.

30. A display apparatus, according to claim 24, wherein:
said frame member includes said support footing member;
said support footing member spacing said frame member from said support surface; and
a plurality of spacing members spacing said support footing member from frame member.

31. A display kit, according to claim 27, wherein:
said flexible covering member includes both said top and said bottom openings; and
at least one of said openings including means for tightening the covering member along said at least one visual plane, whereby said means for tightening minimizes winkles in said covering member and enhances smooth viewing of visual image.

32. A display kit, according to claim 31, wherein:
said top opening includes said means for tightening;
said means for tightening further comprising:
at least one of a plurality of adjustable strips, a draw-string means, an elastic member, a cross-laced means, a combination of said adjustable strips and said elastic member; and a combination of said elastic member and said draw-string means.

33. A display kit, according to claim 31, wherein:
said bottom opening includes said means for tightening;
said means for tightening said bottom opening further comprising:
at least one of a plurality of adjustable strips, a draw-string means, an elastic member, a cross-laced means, a combination of said adjustable strips and said elastic member; and a combination of said elastic member and said draw-string means.

34. A display kit, according to claim 32, wherein:
said bottom opening includes said means for tightening;
said means for tightening said bottom opening further comprising:
at least one of a second plurality of adjustable strips, a second draw-string means, a second elastic member, a second cross-laced means, a combination of said second adjustable strips and said second elastic member;
and a combination of said second elastic member and said second draw-string means.

35. A display kit, according to claim 23, wherein:
said lighting assembly further comprises at least one of a sound projecting unit and a scent projecting unit.

36. A display kit, comprising:
a support frame member defining an inner volume;
said support frame member comprising at least first and second rigid side supports joining top and bottom sections;
each said side support having a first length;
a flexible covering member including means for removably covering said frame member and bounding said inner volume therein;
said support frame supporting and tensioning said covering material along at least one visual plane effective to position at least one visual image for easy visual approach by an external viewer;
said support frame member including means for rapidly assembling and disassembling said frame member, whereby elements of said frame member may be rapidly assembled and disassembled by a user allowing easy storage and transportation in a compact shape; and
at least one lighting assembly positioned within said bounded inner volume and projecting an illumination on said covering material to enhance a perception of said visual image on said flexible covering.

37. A display kit, comprising:
a support frame member defining an inner volume;
said support frame member comprising at least first and second rigid side supports joining top and bottom sections;
each said side support having a first length;
a flexible covering member including means for removably covering said frame member and bounding said inner volume therein;
said support frame supporting and tensioning said covering material along at least one visual plane effective to position at least one visual image for easy visual approach by an external viewer; and
at least one lighting assembly positioned within said bounded inner volume and projecting an illumination on said covering material to enhance a perception of said visual image on said flexible covering.

38. A display kit, comprising:
a support frame member defining an inner volume and including at least a plurality of upright elements having a first length;
a replacement plurality of upright elements having at least a second length;
said support frame member including means for rapidly assembling and disassembling said frame member, whereby said plurality of upright elements having said first length in said frame member may be rapidly assembled with a connective plurality of cross elements and replaceably interchanged with said plurality of uprights have said second length, thereby allowing a user to rapidly assemble support frames of at least first and second heights and rapidly disassemble said support frame for storage and transportation in a compact size;
at least one flexible covering member including means for removably covering said frame member at a selected height and bounding said inner volume therein; and
said support frame supporting and tensioning said covering material along at least one visual plane effective to position at least one visual image available for easy visual approach by an external viewer.

39. A display kit, comprising:
a support frame member defining an inner volume;
said support frame member comprising at least first and second rigid side supports joining top and bottom sections;
each said side support having a first length;
a flexible covering member including means for removably covering said frame member and bounding said inner volume therein;
said support frame supporting and tensioning said covering material along at least one visual plane effective to position at least one visual image available for easy visual approach by an external viewer; and
said support frame member including means for rapidly assembling and disassembling said frame member, whereby elements of said frame member may be rapidly assembled and disassembled by a user allowing easy storage and transportation in a compact shape.
